(19) United States
(12) Patent Application Publication
(10) Pub. No.: US 2016/0304259 A1
(43) Pub. Date: Oct. 20, 2016

(54) Reclosable Pillow-Shaped Wiper Blade Package

(71) Applicant: Portage Plastics Corporation, Portage, WI (US)

(72) Inventor: Gregg S. Lewis, Middleton, WI (US)

(21) Appl. No.: 15/099,586

(22) Filed: Apr. 14, 2016

Related U.S. Application Data
(60) Provisional application No. 62/147,580, filed on Apr. 14, 2015.

(51) Int. Cl. B65D 75/32; B60S 1/38; B65D 85/68

(52) U.S. Cl. CPC B65D 75/322; B65D 85/68; B60S 1/38; B65D 2585/6885

(57) ABSTRACT

A reclosable wiper blade package for holding a beam-type wiper blade having an adapter cradle of a blade receiving cavity formed in one of a pair of package halves that is configured for snap fit engagement with an adapter of the wiper blade releasably retained in the blade receiving cavity. When an adapter of a beam wiper blade is received in the cradle, pre-curved arms of the blade seated in a generally straight beam seat resiliently urge the adapter away from the beam seat against part of the cradle. A pillow-shaped convexly outwardly bowed cover of the other package half provides an enlarged pillow package style wiper blade viewing window while also overlying and preferably bearing downwardly against one or both the blade arms and adapter capturing and preferably clamping the blade between the cover and the cavity-containing package half more securely retaining the blade therein.

### CROSS-REFERENCE

This application claims a benefit of priority on patent U.S. Application No. 62/147,580, filed Apr. 14, 2015, the entire contents of which are hereby expressly incorporated by reference into the present application.

### FIELD

The present invention relates generally to packaging material. In particular, the present invention relates to a reclosable wiper blade package for packaging a pre-curved beam-blade wiper blade.

### BACKGROUND

Pre-curved beam-type windshield or windscreen wiper blades continue to grow in popularity throughout the United States and the world. Beam-type wiper blades have an elongate beam, typically made of a relatively thin generally rectangular strip of metal, which is substantially continuously curved during manufacture to impart a corresponding substantially continuous curve to an elastomeric, e.g., rubber, wiping element extending outwardly from the beam. Imparting such a substantially continuous curve to the wiping element causes the wiping element to make more uniform contact with a vehicle windshield or windscreen during wiper operation improving the squeegee action of the wiper blade.

Pre-curved beam-type wiper blades offer significant improvement over other types of wiper blades including infinite pressure points to offer uniform contact, lower profile which minimizes view obstruction, improved aerodynamics with less windlift, and they are specifically engineered for highly curved windshields. Overall, pre-curved beam-type wiper blades provide vastly improved performance and durability in all weather conditions.

Numerous challenges have been encountered in making packages that hold pre-curved beam-type wiper blades. The three most common types of packaging used to package merchandise for retail sales including wiper blades are blister packaging, pillow packaging and clamshell packaging. Due to the design of blister and traditional pillow packaging, they are much more susceptible to damage when a customer opens them, with blister packaging being almost impossible to put back together. While pillow packaging, often referred to as a “pillow pack”, offers some aesthetic/marketing advantages over other types of packaging and tends to be less susceptible to damage than blister packaging, pillow packaging typically is poorly suited for holding delicate or easily damaged articles. This is because pillow packaging is formed of a pair of outwardly curved convex package walls having a cross-section shaped like a pillow holding one or more objects inside. Since objects held by pillow packaging are free to move around within the packaging, damage can undesirably occur.

One challenge resulted from the pre-curve of beam-type wiper blades having a greater transverse width than previous conventional articulating framework wiper blades. To minimize package volume and maximize retail display package density, thermoformed reclosable packages have been produced that hold pre-curved beam-type wiper blades in a partially or substantially straightened condition. These packages have a cover for covering a blade-holding cavity formed in a blade-retaining package panel configured to receive the beam-type wiper blade.

Another challenge relates to protecting the wiping element while in the package. Due to the curvature of the beam and the relatively fragile nature of the rubber wiping element, the wiping element can become warped or distorted if it comes into contact with the plastic package. When this happens, the outer tip or squeegee edge of the wiping element may be unable to make substantially continuous contact with a vehicle windshield when the wiper blade is installed, causing streaking to occur during operation.

Another challenge relates to keeping the beam-type wiper blade in a fixed position while in the package without applying pressure to the wiping element. Should either of these occur with a brand new beam-type wiper blade taken right out of the package, customer expectations are not met which can also adversely affect future wiper blade purchasing decisions.

Yet another challenge in beam-type wiper blade packaging is lowering manufacturing costs by forming the package with as little material as possible while still providing a sturdy structure capable of retaining the beam-type wiper blade in a fixed position while in the package without applying pressure to the wiping element.

To address at least the issues outlined above, a clamshell package that will fold around a hinge when opened and closed, mimicking its namesake could be used to provide reusable, cost-effective packaging. Since clamshell packaging is reclosable, its saves store's time, energy and money by virtually eliminating the need for repackaging returned merchandise. In addition, it can allow for more merchandise to be displayed in a store by keeping the merchandise in a certain position, reducing the material and space needed for packaging. Reclosable clamshell packaging is well suited for use with automobile wiper blades, as it provides a simple way for customers to preserve the package for returning the merchandise. Where used for more modern pre-curved beam-type wiper blades, clamshell packaging can be configured to releasably hold beam blades in a partially or even substantially straightened condition while protecting the delicate rubber wiping element of the blade. In doing so, such clamshell packaging can be configured to keep the wiper blade horizontally flush against the package, reducing material and space. An important problem relating to automobile wipers is the deformation of the rubber wiping element attached to the metal beam, which in pillow packaging has a much higher chance of occurring. By keeping the beam flush against a wall of the clamshell package, the wiping element is preserved.

What is needed is a reclosable package that offers the aesthetic appearance of a pillow pack type package in a clamshell package format that can be easily reclosed. What additionally is needed is a reclosable package that securely holds a wiper blade in a straight or at least partially straight condition to optimize the number of packages that can occupy a given volume or retail space.

### SUMMARY

By way of summary, the present invention is directed to a reclosable wiper blade package and a wiper blade. The wiper blade may include an elongate pre-curved beam-blade wiper blade having a pair of elongate blade arms extending oppositely outwardly from a wiper blade mounting adapter.

The reclosable wiper blade package may be formed of a pair of package haves joined by a hinge with one of the package halves comprising a cover and the other of the package halves comprising a blade-retaining package panel having a biasing cradle configured to receive and releasably retain the adapter of the wiper blade while resiliently biasing the pair of elongate blade arms against a beam seat ledge. The biasing cradle may engage the wiper blade mounting adapter to bias the pair of elongate blade arms against the beam seat ledge. When the wiper blade is received in the blade-receiving cavity, the mounting adapter is engaged by the biasing cradle and the elongate blade arms are disposed in a partially straightened condition. Additionally, when the wiper blade is received in the blade-receiving cavity, the mounting adapter is engaged by the biasing cradle and the elongate blade arms are disposed in a substantially straightened condition.

The biasing cradle and beam seat ledge may be formed to provide snap-fit engagement with the wiper blade when the wiper blade is received in the blade-receiving cavity to releasably retain the wiper blade in the blade-receiving cavity. The beam seat ledge may be substantially straight, such that the pair of elongate blade arms is straightened against the beam seat ledge.

The biasing cradle may include a plurality of opposed spring fingers configured to engage opposing sides of the wiper blade mounting adapter. The opposed spring fingers may be configured to engage wiper blade mounting of different dimensions

The blade-retaining package panel has a stiffening rib that extends around at least a portion of the blade-retaining package panel to provide added strength to the blade-retaining package panel as well as the package itself. The stiffening rib may engage an outer wall of the cover when the package is in a closed configuration.

Additionally, the package may include a plurality of snap closures for holding the package in a closed configuration. For instance, a plurality of snap closures may protrude internally from an outer wall of the cover. In this case, the plurality of snap closures allows the cover to be releasably engaged with the blade-retaining package panel. The snap closures may also include a tab lock that is engaged to secure the cover to the blade-retaining package panel.

The wiper blade may additional have an elongate flexible wiping element that extends outwardly from the pair of blade arms along substantially the length of the wiper blade. The elongate flexible wiping element may have an elongate outer squeegee edge that may be spaced from the cover and the blade-retaining package panel. By spacing the elongate outer squeegee edge, damage and warping that can occur due to contact with the cover or the blade-retaining package panel can be minimized.

The cover may be convexly outwardly curved substantially across the length of the cover with a portion of the convexly curved cover disposed adjacent the package hinge and overlying the adapter and/or one or both wiper blade arms more securely retaining the wiper blade in the package cavity when the cover is closed by preventing the adapter and/or either wiper blade arm from popping out of the package cavity. Such a convexly outwardly bowed or curved pillow-shaped cover provides the increased packaged wiper blade viewing surface area of a “pillow pak” or pillow-type package in a reclosable clamshell package configuration that also advantageously overlies, preferably bears against and more preferably clamps on or against the adapter and/or a beam, end cap(s) and/or airfoil of one or both wiper blade arms.

Such a pillow-shaped reclosable clamshell wiper blade package of the present invention has a beam blade receiving cradle and wiper beam seat opposed and spaced from the cradle enabling an adapter to be releasably yet securely seated in the cradle with the force of the pre-curved wiper blade arms bearing against a ledge when seated on the beam seat. The adapter preferably also has an outwardly projecting adapter retainer finger that is received in one side of an adapter seated in the cradle and the beam seat has an outwardly projecting adapter retainer lip that is received in an opposite side of the seated adapter providing snap-fit engagement with the adapter that helps keep the adapter from popping out of the seat. When the convexly outwardly curved cover is closed over a beam blade wiper blade received in the cavity with its adapter seated in the cradle, a retainer band that is a portion of an outer wall of the cover adjacent the hinge overlies each wiper blade arm and the adapter more positively retaining one or both the adapter in the cradle and/or each blade arm in its beam seat by overlying the adapter and both blade arms and preferably by bearing against one or both the adapter and the blade arms when the cover is closed.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### DRAWING DESCRIPTION

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a top front perspective view of a reclosable pillow-shaped package constructed in accordance with the present invention in an opened condition;

FIG. 2 is a top front perspective view of a reclosable pillow-shaped package with a tuck under lid lock latching arrangement constructed in accordance with the present invention in an opened condition;

FIG. 3 is an end elevation view of the reclosable pillow-shaped package of FIG. 2 with an elongate beam blade in the package;

FIG. 4 is an end elevation view of the reclosable pillow-shaped package of FIG. 2 with an elongate beam blade packaged, the package shown in a closed condition with the convexly outwardly curved cover overlying the wiper blade preventing the blade from disengaging from a package cavity containing package panel;

FIG. 5 is a transverse cross-section view of the reclosable pillow-shaped package of FIG. 2 taken through part of the package holding an adapter of the elongate beam blade;

FIG. 6 is a transverse cross-section view of the reclosable pillow-shaped package of FIG. 2 taken through part of the package that holds an adapter of the elongate beam blade with the beam blade removed;

FIG. 7 is a fragmentary top plan view of the reclosable pillow-shaped package of FIG. 2 shown in an opened condition;

FIG. 8 is another transverse cross-section view of the reclosable pillow-shaped package of FIG. 2;

FIG. 9 is an end elevation of the reclosable pillow-shaped package of FIG. 2 showing the package being closed;

FIG. 10 is an end elevation of the reclosable pillow-shaped package of FIG. 2 where the package is in a closed condition and the latching arrangement in an engaged condition;

FIG. 11 is a partial perspective view of the package closures holding the package in a closed condition; and

FIG. 12 is a partial perspective view of the hook snap is formed and the notch of the package closures.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words “connected”, “attached”, or terms similar thereto are often used. They are not limited to direct connection but include connection through other elements where such connection is recognized as being equivalent by those skilled in the art.

### DETAILED DESCRIPTION

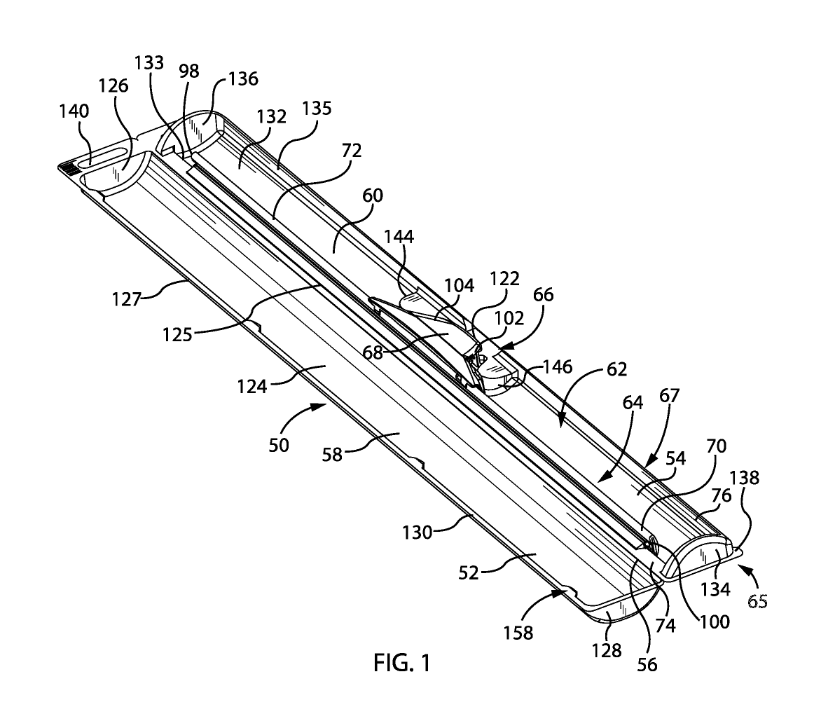

FIGS. 1-5 illustrate a reclosable pillow-shaped wiper blade package 50 that is a clamshell-type package constructed in accordance with the present invention having a pair of package halves 52, 54 joined by a hinge 56 with one of the package halves 52 defining a package cover 58 having an outwardly bowed convex shape and the other one of the package halves 54 defining a wiper blade holding package panel 60 having a recessed three-dimensionally contoured wiper blade receiving cavity 62 formed therein that is configured for receiving and releasably retaining a pre-curved beam-type wiper blade 64 in an at least partially straightened condition and preferably in a substantially straightened condition. Outwardly bowed convexly shaped package cover 58 imparts a pillow package or “pillow pak” like appearance to a package 50 of reclosable clamshell construction that provides increased retail package viewing surface area while allowing the package 50 to be opened and closed at least a plurality of time, preferably at least a plurality of pairs, i.e., at least three, times. Such convexly outwardly curved pillow-shaped cover 58 preferably has a curvature along a transverse direction that varies in a manner so as to space at least part of the cover 58 relative to a beam type wiper blade 64 received in the cavity 62 such that the cover 58 more securely retains the blade 64 in the cavity 62 when closed by capturing the blade 64 while seated in the cavity 62 between the cover 58 and blade holding package panel 60.

Blade holding package panel 60 has a package strengthening arrangement 65 formed at least in part by at least one upraised rib 76 of double-walled construction and generally U-shaped cross-section that is integrally formed therein that preferably extends longitudinally along a lengthwise extending side of the panel 60 opposite the hinge 56 defining side wall(s) 78 and/or 80 and which can bound and/or define at least a portion of the wiper blade receiving cavity 62. If desired, rib 76 can have a generally transversely extending segment disposed at one end of the panel 60 and can have a generally transversely extending segment disposed at an opposite end of the panel 60 forming endwalls 134 and 136 thereof that can and preferably also does define endwalls of the wiper blade receiving cavity 62. Stiffening arrangement 65 preferably not only torsionally stiffens and structurally rigidifies the package 50, but preferably also provides a cover-seating support 67 over which the cover 58 nests when closed. When closed, cover 58 can be and preferably is at least partially supported on each rib 76 of rib arrangement 65 and can be and preferably is at least partially supported along those portions of the cover 58 alongside each rib 76 of rib arrangement 65 that overlap therewith.

As is best depicted by FIGS. 1, 2, and 7, the wiper blade receiving cavity 62 includes a wiper blade adapter receiving cradle 66 that is generally centrally located about the wiper blade receiving cavity 62. The adapter receiving cradle 66 is configured to receive and releasably retain an adapter 68 of the wiper blade 64 in a manner that not only helps orient, center and locate a pre-curved beam type wiper blade 64 inserted into the wiper blade receiving cavity 62, but which preferably also helps releasably retain the blade 64 in the cavity 62 by transversely urging a pair of pre-curved resiliently flexible elongate blade arms 70, 72 of the blade 64 that extend oppositely outwardly from the adapter 68 into releasable blade retaining engagement with an elongate generally longitudinally extending pre-curved beam type wiper blade beam seat 75 of the cavity 62. The adapter receiving cradle 66 can be configured to resiliently bias the blade arms 70, 72 of the pre-curved beam-type wiper blade 64, an elongate and substantially straight ledge 74 of the wiper blade beam seat 75 such that the blade arms 70, 72 are releasably retained in the wiper blade receiving cavity 62 in at least a partially straightened condition and preferably in a substantially straightened condition, even when the cover 58 is open.

When the cover 58 is closed, one or more portions of the cover 58 overlie a corresponding portion of each blade arm 70, 72 of wiper blade 64 seated in the cavity 62 more securely retaining the blade 64 in the cavity 62 by preventing the blade 64 from popping out of the cavity 62, e.g., preventing blade displacement outwardly or upwardly out of the cavity 62 toward the cover 58, and becoming unseated. In a preferred embodiment, one or more portions of the cover 58 that overlie corresponding blade arms 70, 72, or portions, thereof when the cover 58 is closed, releasably capture at least part of each blade arm 70, 72 between the cover 58 and the blade holding package panel 60 helping prevent the blade 64 from popping out or otherwise becoming unseated from the cavity 62. In one such preferred embodiment, the closed cover 58 preferably bears against at least a portion of each blade arm 70, 72 at or adjacent a free end thereof thereby preventing the blade 64 from popping out or otherwise becoming unseated from the cavity 62 preferably by the closed cover 58 resiliently urging the portion of each arm 70, 72 downwardly into the cavity 62.

As best shown in FIGS. 4-6, when the package cover 58 is closed against the blade holding package panel 60, it forms a reclosable clamshell package 50 having a pillow-shaped exterior that is more resilient, stronger, more durable, and which provides such a reclosable clamshell package 50 of the present invention having increased frontal retail display viewing surface area while possessing the same width or footprint as conventional clamshell packages formed with a flat or planar exterior. The convexly outwardly bowed shape of the front or top exterior of the cover 58 of the package 50 preferably defines a convexly curved pillow-shaped outer viewing window 55 that advantageously provides an increased packaged article viewing surface area for a prospective purchaser evaluating the packaged beam type wiper blade 64 on retail display for retail purchase while also helping to more securely retain the wiper blade 64 received in the wiper blade receiving cavity 62 when the cover 58 of the package 50 is closed. Where the package 50 is also equipped with a card (not shown) having printed indicia related to the wiper blade 64 in the package 50, the card preferably is carried by the cover 58 and disposed in the window 55 with the increased viewing surface area provided by the convexly outwardly bowed pillow shape of the window 55 enabling a larger card with a greater surface area of imprinted indicia to be used in the package 50 when compared to conventional clamshell packages formed with a flat or planar exterior.

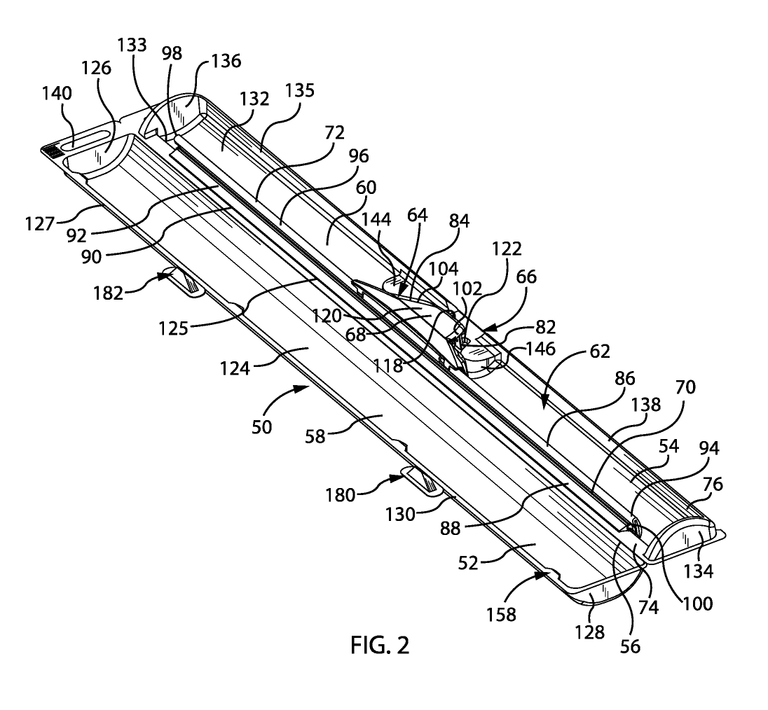

With reference to FIGS. 1 and 2, the wiper blade 64 is an elongate pre-curved beam-type or beam-blade wiper blade 64 having a pair of elongate longitudinally extending pre-curved flexible wiper blade arms 70, 72 extending oppositely outwardly from a corresponding endwall 82, 84 of the wiper blade adapter 68. The blade arms 70, 72 are formed of an elongate longitudinally extending pre-formed or pre-curved beam 86 from which an elongate longitudinally extending flexible elastomeric wiping element 88 outwardly extends in one direction that has a narrowed outer squeegee edge or wiping element tip 90 defining a windscreen or windshield wiping squeegee 92. The wiper blade 64 can have an elongate longitudinally extending outer blade arm cover 94 on each blade arm 70, 72 that can be in the form of an elongate airfoil 96 extending outwardly from the beam 86 in a direction opposite the squeegee 92. If desired, the end of each blade arm 70, 72 can be covered by an end cap 98, 100.

The wiper blade adapter 68 has a pair of spaced apart longitudinally extending sidewalls 102, 104 extending between the adapter endwalls 82, 84 and a bottom 112. A corresponding top edge 120 extends between the adapter sidewalls 102, 104 with a top recess 118 formed in the top 120 of the adapter 68, which forms a wiper arm receptacle 122 in which a free end of a reciprocable vehicle windshield or windscreen wiper arm (not shown) of an automotive vehicle (not shown) is releasably received in attaching the wiper blade 64 thereto.

The reclosable wiper blade package 50 is shown in an open position in FIGS. 1-3 and 6 and in a closed position in FIGS. 4-6. The wiper blade package 50 includes a first package half 52, herein referred to as the cover 58, and a second package half 54, herein referred to as the wiper blade holding package panel 60. The wiper blade package 50 may be formed using any one of a number of suitable manufacturing methods, but preferably is vacuum thermal formed, e.g., thermoformed, of a relatively thin sheet of polyester resin, such as polyethylene terephthalate, commonly referred to as PET. Other plastics, such as polyvinyl chloride, polyethylene tetraglycol (PETG), a styrene, a K-resin, or the like can also be used to form a package 50 constructed in accordance with the present invention. Such a plastic sheet is relatively thin, having a thickness of between 0.0075 inches and 0.075 inches, with a typical thickness ranging between about 0.080 and about 0.070 inches, preferably on the order of about 0.010 inches, producing a relatively clear or see-through package 50 having a corresponding thickness when thermoformed.

The cover 58 preferably is elongate and generally rectangular in perimeter, although the transverse cross section of the cover 58 is convexly outwardly curved across substantially the entire width of the cover 58, imparting a pillow-like appearance to reclosable clamshell package 50. As best seen in FIGS. 4 and 6, an outer wall or top side 124 transversely extends between a first side edge 125 and a second side edge 127 of the cover 58 with the outer wall or top side 124 of the cover 58 being substantially semicircular in shape, with a pair of spaced apart generally transversely extending end walls 126, 128 generally defining a top and bottom of the cover 58. The outer wall or top side 124 of the cover 58 longitudinally extends between the two end walls 126, 128 so as to overlay the blade receiving cavity 62 and wiper blade 64 when the package 50 is closed. Such an outwardly convexly curved cover 58 advantageously not only straightens and structurally rigidifies the package 50 when closed, but the outer wall or top side 124 of the cover 58 also defines viewing window 55 that provides increased viewing surface area of the wiper blade 64 within and/or retail display card carried by the cover 58. The cover 58 preferably also includes a substantially flat cover flange 130 extending outwardly about the perimeter of the cover 58.

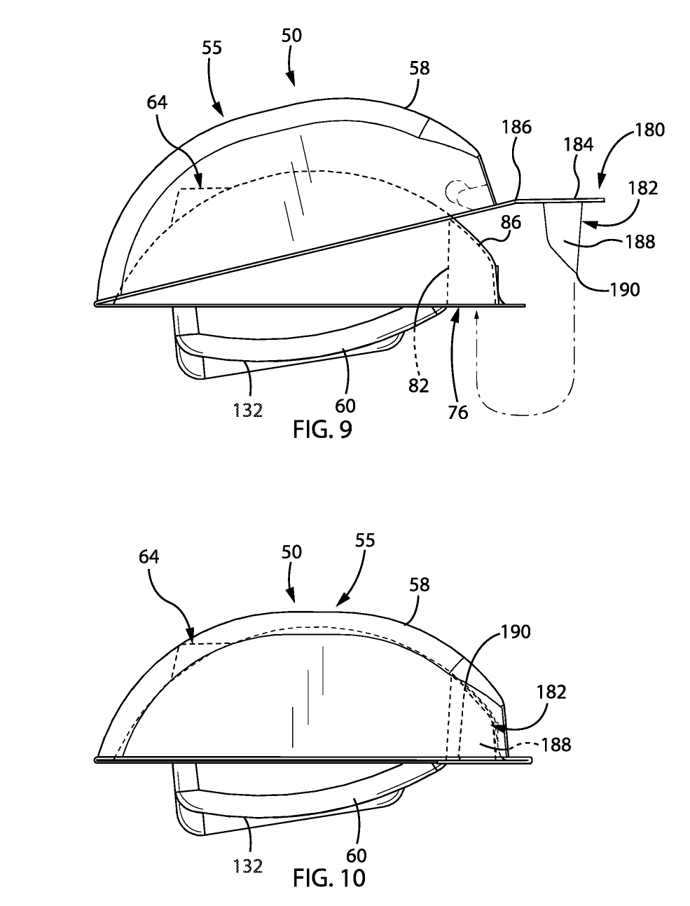

The blade holding package panel 60 can be and preferably is also elongate and generally rectangular in perimeter. Like the cover 58, the blade holding package panel 60 is convexly outwardly curved and has a floor 132 which extends between a first side edge 133 located adjacent to the hinge 56 and a second side edge 135 located on the opposite side of the blade-holding package panel 60. Floor 132 can be and preferably is convexly outwardly curved along portions of the floor 132 disposed outwardly from and on either side of the adapter cradle 66 as depicted in FIGS. 9 and 10. Each such convexly outwardly curved portion of the floor 132 located on each or both sides of the adapter cradle 66 preferably is semicircular in cross-section. The blade holding package panel 60 can and preferably does have two longitudinally spaced apart generally transversely extending end walls 134, 136, with the floor 132 extending therebetween. The end walls 134, 136 and floor 132 define at least portions of corresponding sides and ends of the wiper blade receiving cavity 62 as also shown in FIGS. 1 and 2. End walls 134 and 136 together with sidewall(s) 78 and/or 80 form at least part and preferably form substantially the entire stiffening arrangement 65 of the package panel 60 that is defined or provided by at least one upraised rib 76. End walls 134 and 136 are formed by generally transversely extending segments of at least one rib 76 formed in package panel 60 and preferably define respective opposite end walls of not only the package panel 60 but also define the end walls of the package cavity 62. Sidewall(s) 78 and 80 are formed of at least one elongate longitudinally extending segment of at least one rib 76 formed in package panel 60 that extend along a side of the package panel 60 opposite the hinge 56 that preferably defines not only a sidewall of the package panel 60 but also a sidewall of the package cavity 62. Like the cover 58, the blade holding package panel 60 has a blade retaining package panel flange 138 that extends outwardly about the perimeter of the panel 60. As is best shown in FIGS. 1, 2, and 6, the panel flange 138 extends outwardly from the side of the floor 132 and panel endwalls 134, 136.

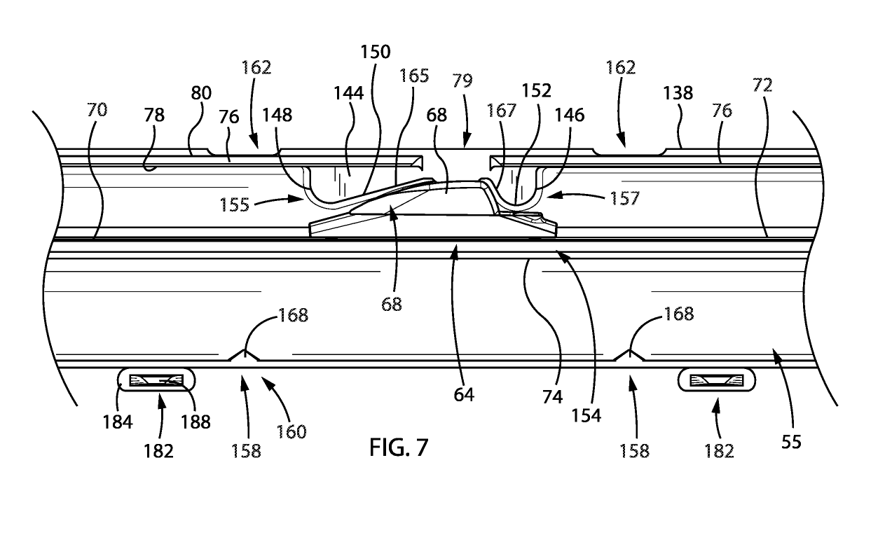

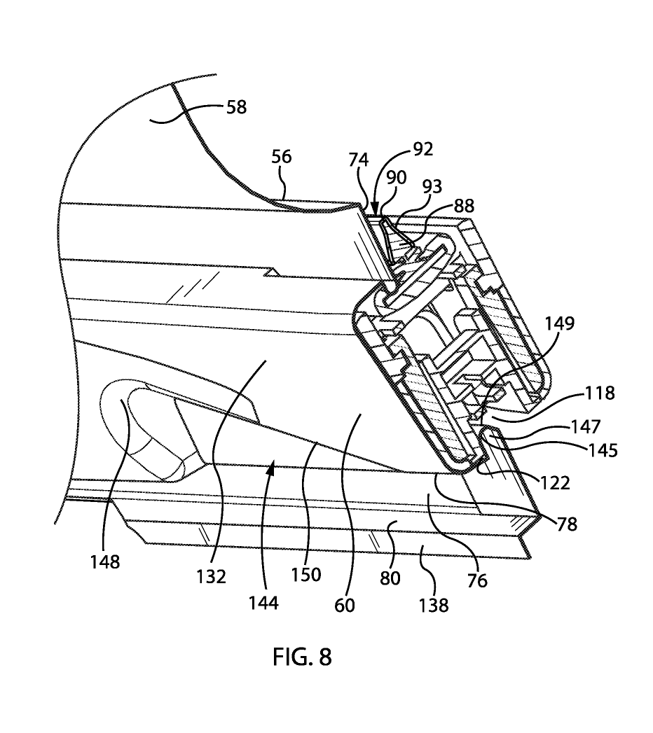

In a preferred embodiment of the package panel 60, the at least one rib 76 of the stiffening arrangement 65 is generally U-shaped with longitudinally extending segment of rib 76 that forms sidewall(s) 78 and 80 extending substantially the entire length of the package panel 60 from one generally transversely extending segment of rib 76 that forms endwall 134 to the other generally transversely extending segment of rib 76 that forms opposite endwall 136. In another preferred embodiment of the package panel 60, the generally longitudinally extending segment of rib 76 is interrupted by a thumb or finger access clearance 79 disposed therebetween as depicted in FIG. 7 and adjacent to the adapter cradle 66 to facilitate insertion and/or removal of the adapter 68 when removing or seating the wiper blade 64. Where longitudinally extending segment of rib 76 is interrupted by such a thumb or finger access clearance 79, stiffening arrangement 65 preferably is formed by two generally L-shaped rib segments with one generally L-shaped rib segment including generally transversely extending segment of rib 76 that forms one endwall 134 and a generally longitudinally extending first rib segment of rib 76 that forms one section of sidewall(s) 78 and 80 extending from endwall 134 to access clearance 79 and another generally L-shaped rib segment that includes generally transversely extending segment of rib 76 that forms the other endwall 136 and a generally longitudinally extending second rib segment of rib 76 that forms the other section of sidewall(s) 78 and 80 extending from endwall 136 to access clearance 79. Each end wall 134 and 136 preferably is curved and preferably generally semicircular having a curved outer or top rib edge or surface that faces towards the cover 58 upon which an inner surface of the cover 58 can rest and preferably upon which the cover 58 is supported when the cover 58 is closed.

Formed in or adjacent one end, e.g., a top end 128, 136, of both the cover flange 130 and panel flange 138 is a hanger hole 140, 142. When the wiper blade package 50 is closed, the flanges 130, 138 overlap one another such that the hanger holes 140, 142 in each flange 130, 138 line up to one another allowing the wiper blade package 50 to be hung on a hook (not shown) of a retail display or the like.

The wiper blade package 50 is designed to hold the pre-curved beam type wiper blade 64 in the blade receiving cavity 62 of the blade holding package panel 60 in at least a partially straightened condition. The wiper blade package 50 preferably is designed to receive and releasably retain the pre-curved beam type wiper blade 64 in the blade receiving cavity 62 of the blade holding package panel 60 in a substantially straightened condition like that shown in FIGS. 1, 2, and 6. Such pre-curved beam type wiper blades 64 commonly include an adapter 68 disposed between blade arms 70, 72 with the adapter 68 preferably located in a generally central location of the wiper blade 64. The adapter 68 allows the wiper blade 64 to be removably attached to a wiper arm of a vehicle (not shown). The pre-curvature of the beam 86 creates added pressure pushing a tip 90 of its squeegee 92 of its wiping element 88 against a windshield or windscreen (not shown) of a vehicle (also not shown), e.g., automotive vehicle, allowing it to more effectively remove water. The squeegee 92 is formed of a wiping element 88 made of a flexible material that preferably is an elastomeric material, such as rubber or silicone. In order to remain optimally effective, at least the wiping edge or tip 90 of the squeegee 92 must be prevented from experiencing any pressure or deformation while it is stored in the wiper blade package 50, including during transportation, storage and/or even while remaining on display in a retail store. This particularly true where the wiper blade 64 is stored in the wiper blade package 50 for an extended period of time within the package 50 during transportation, warehousing, or while remaining on display in a retail store. Additionally, if desired, at least the wiping edge or tip 90 of the squeegee 92 can be covered or encapsulated by a removable protective sleeve 93 of plastic construction that typically can be and preferably is telescopically slidably mounted on or over part of the wiping element 88 such that the sleeve 93 surrounds and protects the tip 90 while the wiper blade 64 is in the package 50. Once a wiper blade 64 equipped with such a squeegee protecting sleeve 93 is removed from the package 50, the sleeve 93 can then be slid off of the wiping element 88 to expose the squeegee 92 thereby readying the wiper blade 64 for actual use.

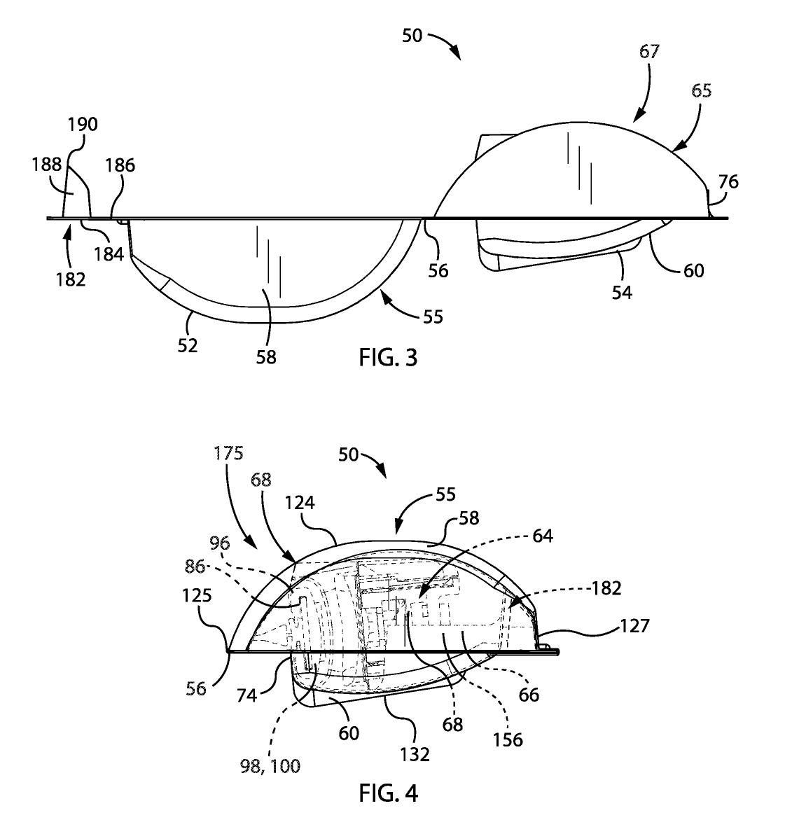

As indicated, the wiper blade package 50 is configured to securely and yet releasably retain such a pre-curved beam-type wiper blade 64 in a manner that prevents contact between the package 50 and the wiping edge or tip 90 of a squeegee 92 of a wiper blade 64 held in the closed package 50. Advantageously, such a reclosable wiper blade package 50 constructed in accordance with the present invention preferably also is configured in such a manner that enables the package 50 to also be able to hold a beam type wiper blade 64 that is inserted into the package 50 with such a removable squeegee protecting sleeve 93 already mounted to the blade 64 and covering the squeegee 92. As shown best in FIGS. 3-5, the ability of the package 64 to hold a beam type wiper blade 64 without contacting any part of its squeegee 92, including without contacting any part of the wiping edge or tip 90 of squeegee 92, even when packaged without sleeve 93, is accomplished with a three dimensionally formed wiper blade receiving cavity 62 that includes a recessed wiper blade adapter receiving cradle 66 and a beam seat 75 with a beam seat ledge 74 opposite the biasing cradle 66 that is transversely spaced from the cradle 66. As a result, the wiper blade receiving cavity 62 is configured for receiving and releasably retaining a pre-curved beam-type wiper blade 64 in at least a partially straightened condition, and preferably in a substantially straightened condition, by seating of the wiper blade arms 70, 72 along the beam seat ledge 74 of beam seat 75 while keeping the wiping edge or tip 90 of the squeegee 92 of a wiper blade 64 from contacting any part of the reclosable package 50 while received in the cavity 62, including while the package 50 is closed. In the preferred reclosable wiper blade package 50 embodiment shown in the drawing figures, the wiper blade receiving cavity 62 is three dimensionally formed in a manner that receives and releasably retains such a pre-curved beam-type wiper blade 64 in an at least partially straightened condition and preferably in a substantially straightened in a generally sideways wiper blade orientation with the wiper blade 64 disposed on its side in the cavity 62 with the wiping edge or tip 90 of the squeegee 92 of the blade 64 extending generally horizontally transversely relative to the package hinge 56 in a direction generally facing the hinge 56. When blade 64 is inserted or otherwise received in cavity 62, the blade 64 preferably is oriented on its side with its wiping edge or tip 90 of the squeegee 92 of the blade 64 extending generally horizontally outwardly toward the package hinge 56.

Looking to FIGS. 1, 2, 6, and 7, the adapter cradle 66 is formed in the blade holding package panel 60 with a generally complementarily shaped wiper blade adapter receptacle 154 that can be and preferably is formed in at least part of at least a plurality of wiper blade adapter supporting fingers 144 and 146, which can include a plurality of pairs, i.e., at least three, fingers 144, 145, 146. In the preferred cradle embodiment depicted in FIG. 7, wiper blade adapter supporting fingers 144 and 146 are formed of adapter walls 155 and 157 each curved and/or angled to at least partially complementarily conform to a corresponding adjacent curved and/or angled portion of adapter 68 received in the cradle 66. Wiper blade supporting fingers 144, 146 are substantially curvilinear in shape and extend generally inwards from or adjacent the inner rib wall 80 of the blade-holding package panel 60, with the fingers 144, 146 spaced apart by adapter 68 and having respective adapter biasing support 165, 167 of each adapter support finger 144, 146 generally extending toward one another and preferably bracketing opposite sides of adapter 68. In a preferred embodiment, each adapter biasing support 165, 167 backstops corresponding adjacent portion of adapter 68 as best depicted in FIG. 7 such that adapter 68 can abut against one or both supports 165 and/or 167 when the beam blade arms 70, 72 of seated wiper blade 64 resilient urge the adapter 68 thereagainst.

With continued reference to FIG. 7, adapter finger 144 has a round section 148 and an extended tapered section 150. The other adapter finger 146 has only a round section 152 that terminates. The adapter fingers 144, 146 are configured to straddle opposite sides of the beam blade adapter 68 with their respective adapter biasing supports 165, 167 backstopping adjacent portions of adapter 68 and resiliently urging the adapter 68 towards the beam seat ledge 74 in response to the spring-like wiper blade arms 70, 72 resiliently pushing against ledge 74 urging adapter 68 thereagainst. More specifically, the first adapter support finger 144 straddles first adapter sidewall 102 and tapers gradually towards the wiper blade. As a result, the round section 148 abuts an outer edge of the first adapter sidewall 102, and the extended tapered section 150 abuts an adjacent sloped portion of the first adapter sidewall 102. The second adapter support finger 146 and more specifically the rounded portion 152 abuts the second adapter sidewall 104, which extends substantially vertically away from wiper blade 64 at a greater angle than the first adapter sidewall 104. Thus, the resilient adapter biasing support 165 of the first adapter support finger 144 backstops and preferably also resiliently urges the first adapter sidewall 102 towards the second adapter support finger 146 preferably also urging or helping urge adapter 68 towards beam seat ledge 74, and the resilient adapter biasing support 167 of the second adapter support finger 146 urges the second adapter sidewall 104 towards the first adapter support finger 144 preferably also urging or helping urge adapter 68 towards beam seat ledge 74. Preferably, the adapter support fingers 144, 146 can be and preferably are stamped into the floor 132 of the blade-holding package panel 60 such that the fingers 144, 146 are upraised and integrally formed in the floor 132 substantially perpendicular to the floor 132.

Finger 145 preferably is an adapter retainer that can be of snap-fit configuration that is disposed between adapter support fingers 144 and 146 that extends outwardly from part of the package panel 60 and which is received in a pocket or other recessed part of adapter 68 seated in cradle 66 when wiper blade 64 is inserted into package cavity 62. Adapter retainer finger 145 can be and preferably is substantially linear and extends to form a lip 147 that directly engages a top edge 120 of the adapter 68. The tip 149 of the lip 147 and the beam seat ledge 74 are spaced apart by a distance less than the adapter 68 to provide at least a friction fit therebetween and preferably a snap fit with the adapter 68. Preferably, the adapter retainer finger 145 is integrally molded or otherwise formed substantially horizontally from the second side edge 135 so that the lip 147 extends towards the beam seat ledge 74.

As a result of this configuration of the fingers 144, 145, 146, the adapter 68 can be secured by fingers 144, 145, 146. More specifically, the adapter retainer finger 145 is received in the top recess 118 formed into the top edge 120 of the adapter 68. The adapter retainer finger 145 can bias the adapter 68 toward the beam seat ledge 74 such that the blade arms 70, 72 are straightened against the beam seat ledge 74 but adapter retainer finger 145 preferably engages the adapter 68 in a manner that helps keep the adapter 68 from popping out of the cradle 66. The round sections 148, 152 of the fingers 144, 146 allow the fingers 144, 146 to support by backstopping the adapter 68 when the blade arms 70, 72 push back against beam seat 75 urging adapter 68 against fingers 144, 146 helping to securely retain the adapter 68 within cradle 66. These portions of cradle 66 preferably also backstop and thereby support the adapter 68 in the cradle 66 against the force of the wiper blade arms 70, 72 seated in the beam seat 75 pushing against the seat 75 and/or ledge 74 of the seat 75 urging the adapter 68 against one or both support fingers 144, 146 of cradle.

Adapter cradle 66 preferably is further configured to provide at least frictional engagement that can be elastically deflecting engagement between the adapter retainer finger 145, the adapter 68, and a generally centrally located adapter retainer lip 85 outwardly projecting from beam seat ledge 74 to positively yet releasably retain the adapter 68 in the biasing cradle 66, as well as keeping the adapter 68 disposed between the fingers 144, 146 to keep the adapter 68 seated in the cradle 66 and thus help keep the wiper blade 64 centered about the biasing cradle 66. When seated in cradle 66, adapter 68 preferably is releasably captured between adapter retainer finger 145 received in one portion, e.g., a top portion, of adapter 68, and adapter retainer lip 85 of beam seat ledge 74 received in another portion, e.g., a bottom portion, of adapter 68, releasably capturing the adapter 68 therebetween. Adapter retainer finger 145 and adapter retainer lip 85 preferably are configured to provide a snap fit with the cradle 68 when adapter 68 is being seated in cradle 66 during insertion of wiper blade 64 into cavity 62. Therefore, in use the cradle 66 receives and releasably retains the adapter 68 of a pre-curved beam-type wiper blade 64 being inserted into the wiper blade receiving cavity 62, but also helps orient the wiper blade 64 sideways within the cavity 62. In a preferred embodiment, the adapter retainer finger 145 of the cradle 66 and adapter retainer lip 85 of the beam seat and/or beam seat ledge is configured to provide snap fit engagement with spaced apart portions of the wiper blade adapter 68 when inserted into cradle 66 with a preferred cradle embodiment configured to provide snap fit engagement with oppositely located portions of the adapter 68.

The beam seat ledge 74 preferably extends generally transversely along the blade holding package panel 60 adjacent to the hinge 56 such that the wiping element 88 is supported thereby, preferably by at least a portion of the side of the wiping element 88 resting thereon. When the adapter 68 is seated in the cradle 66 and the side of the wiping element 88 resting on the beam seat ledge 74, the wiping element tip 90 or windshield wiping squeegee 92 is spaced above the ledge 74 and any other adjacent part of the beam seat 75 thereby spacing the tip 90 and squeegee 92 from any part of the blade holding package panel 60 and cover 58. As such, the package 50 advantageously protects the integrity of the tip 90 and/or squeegee 92 from deformation when the blade 64 is seated in the package cavity 62 and the package 50 is closed. Additionally, as discussed above, package 50 is also advantageously configured to accommodate when the squeegee 92 of the wiper blade 64 has a protective sleeve 93 that slidably covers the squeegee 92 to further protect the squeegee 92. Once the wiper blade 64 is removed from the package 50, the cover 93 can be slid off of the squeegee 92 so that the wiper blade 64 can be installed about a vehicle.

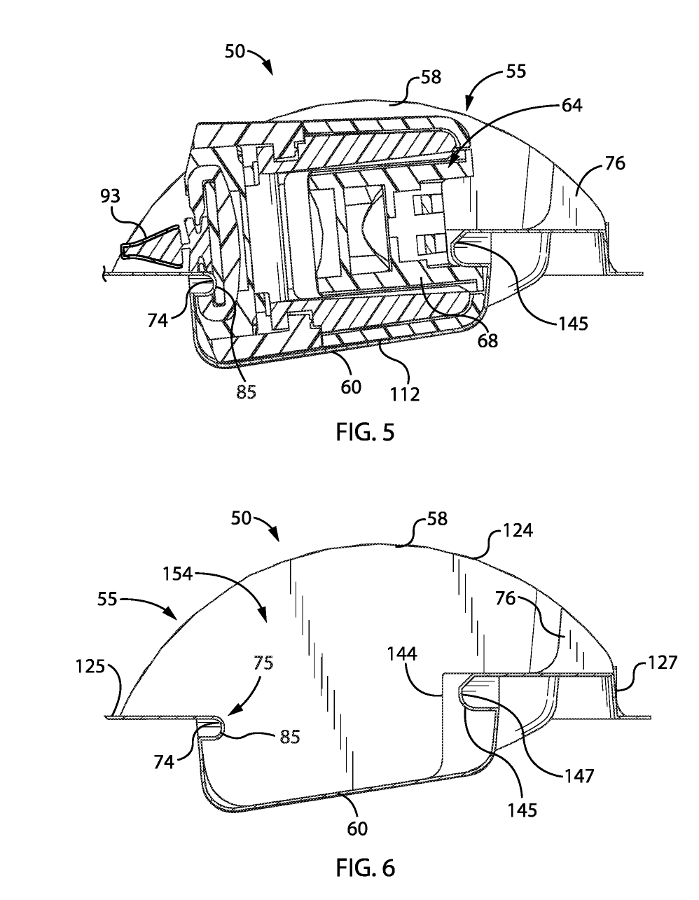

As is shown in FIGS. 1-5 and 7, when the adapter 68 of a wiper blade 64 has been snapped into the cradle 66, the adapter retainer finger 145 resiliently bias the adapter 68 in a manner that prevents the adapter 68 from popping out of the cradle 66 by being received in a pocket or other recessed portion of the adapter 68 in the manner depicted in FIG. 5 thereby releasably interfering with removal of the adapter 68 from cradle 66. In turn, the adapter 68 and the entire wiper blade 64 are pushed towards the beam seat ledge 74 located opposite the blade-holding package panel 60. As a result, the wiper blade 64 and more specifically the blade arms 70, 72 are pressed against the beam seat ledge 74, which is substantially straight. Therefore, the wiper blade 64 is removably yet securely held within the wiper blade receiving cavity 62 between the cradle 66 and the beam seat ledge 74. Thus, the blade arms 70, 72 are held substantially straight despite the pre-curved nature of the wiper blade 64. Additionally, adapter support fingers 144, 146 help hold the adapter 68 in place in the cradle 66, and also help support by providing a backstop to the adapter 68 being urged thereagainst by the force of the wiper blade arms 70, 72 pushing against the beam seat ledge 74. In a preferred package embodiment, releasable engagement between the fingers 144, 145, 146 and the wiper blade adapter 68 received in the cradle 66 helps securely, positively and yet releasably retain the wiper blade 64 in the wiper blade receiving cavity 62.

As is best shown in FIGS. 1-7, the cradle 66 can and preferably does include an elongate longitudinally extending adapter receptacle 154 formed in an upraised cover support 156 with the receptacle 154 having a generally oblong or oval shape that is substantially complementary to that of the shape of the adapter 68 to not only help securely yet releasably retain the adapter 68 in the cradle 66 but also to help longitudinally locate and/or position the blade arms 70, 72 of the blade 64 relative to the beam seat 75 so the blade arms 70, 72 bear against the beam seat ledge 74 of the wiper blade receiving cavity 62 located on the opposite side of the wiper blade receiving cavity 62 as the biasing cradle 66. The substantially complementary shape of the adapter cradle receptacle 154 with the wiper blade adapter 68 also helps orient the wiper blade 64 sideways within the wiper blade receiving cavity 62, as well as position each blade arm 70, 72 so the blade arms 70, 72 seat on or against the beam seat ledge 74 in a substantially straightened condition in the package 50 with one side of the wiping element 88 resting thereon in a manner such as previously discussed above.

With reference to FIGS. 1, 2, and 7, elongate rib 76 is formed around the blade-holding package panel 60 sidewall 135 and each one of the blade-holding package panel 60 endwalls 134, 136 with a pair of spaced apart rib sidewalls 78, 80. The rib 76 may be formed into a generally V-shaped or U-shaped rib cross-section. This rib 76 increases the strength, stiffness and flexural rigidity of the blade-holding package panel 60 as well as the wiper blade receiving cavity 62 helping a closed package 50 to better withstand force(s) applied thereto including by the substantially straightened beam-type wiper blade 64 in the package 50 even when the package 50 is subjected to external bending and/or twisting forces.

Referring now to FIGS. 4-6, the package 50 is shown in the closed position and is retained in the closed position with the use of releasable package closures 158, such as depicted in FIGS. 7, and 9-12. While at least a plurality and preferably at least a plurality of pairs, i.e., at least three, e.g., four, package closures 158 are shown in the figures, any number of similar closures 158 may be used and spaced about the perimeter of the reclosable package 50 of the present invention. The package closures 158 form a hook snap 160 that is a two-part package closure system. One part may be formed in the cover 58, along the cover flange 130 and the mating part may be formed in the blade-holding package panel 60, along the blade-retaining package panel flange 138. Either part of the hook snap 160 of each such package closure 158 may be formed in either the blade-holding package panel 60 or cover 58.

Looking now to FIGS. 9 and 10, preferably, the hook snap 160 of each such package closure 158 is formed with two parts, a snap-receiving notch 162 that preferably is a recessed trimmed edge 166 formed in the second side edge 135 of the blade-holding package panel 60, and an edge engaging projection 166 that preferably is a snap hook 168 extending outwardly from the cover 58. The notch 162 may be formed by trimming or stamping notch 162 from or into the flange 138 and the second side edge 135 of the blade-holding package panel 60. Where the package 50 is equipped with a retail display card with indicia related to the wiper blade 64 held in the package 50, one or more of the hooks 168 can double as a card holder that helps retain card against the underside of the viewing window 55 of the cover 58.

When the hook snap 160 is moved towards engagement the projections 166, or snap hooks 168, extend from the interior of the cover 58 towards the notch 162 in the second side edge 135 of the blade holding package panel 60. As previously mentioned, the hook 60 may extent from either the base 22 or cover 28 with the receiving notch 38 formed in the other one of the base 22 or cover 28.

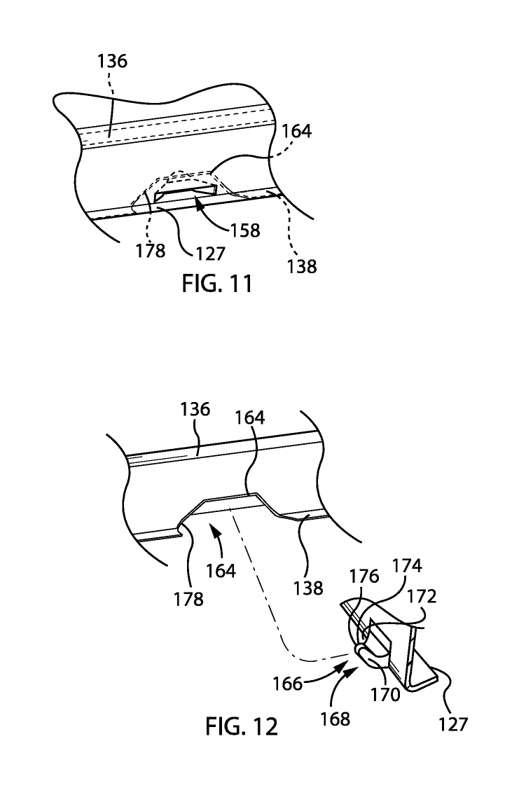

Referring to FIG. 11, a hook 168 projects from the second side edge 127 of the cover 58 inwardly of the cover 58, shown best in FIG. 1. A notch 162 is cut out of the second side edge 135 in the blade-holding package panel 60 that receives the hook 168, thus retaining the cover 58 in the closed position. The hook 168 includes a hook arm 170 extending upwardly curving away from the second side edge 127 of the cover 58 forming a gap 172 between the cover second side edge 127. The point 174, or vertex 176 of the curved hook 168 is inserted behind the notch 162 in the trimmed edge 164 of the blade-retaining package panel flange 138 and second side edge 135 such that the point 174 latches onto the trimmed edge 164 to keep the cover 58 in the closed position as shown in FIGS. 3-5. The notch 162 functions as a hook receiver 178 to retain the point 174 of the hook 168 and keep the trimmed edge 164 against the gap 174 of the hook 168. The use of these package closures 158 allow the package 50 to be repeatedly opened and re-closed a number of times while still maintaining integrity to the package 50.

In addition to the package closures 158 discussed above, the package may additionally include a releasable latching arrangement 180, for instance, a plurality of tuck under lid locks 182 as shown in FIGS. 2 and 3. While two tuck under lid locks 182 are shown in the figures, any number of tuck under lid locks 182 may be used about the perimeter of the reclosable package 50. As shown, the cover 58 flange 130 includes a number tuck under lid locks 182, although a similar latching arrangement could be located along the flange 138 of the blade-holding package panel 60. Each of the tuck under lid locks 182 includes a body 184 extending horizontally away from the flange 138. The body 184 is pivotable about a pivot point 186 located where the body 184 meets the flange 138. The tuck under lid lock 182 also includes a hook 188 that extends downwardly from the body 184 to a point 190. The tuck under lid lock 182 may be used when the package 50 is in the closed position to further secure the two package halves 52, 54 together. For instance, once the cover 58 is rotated about the hinge 56 such that the cover 58 covers the blade-holding package panel 60, the tuck under lid locks 182 can be pivoted about the pivot point 186. When pivoted about the pivot point 186, the body 184 wraps around the second side edge 135 of the blade-holding package 60. The hook 188 can then extend into the rib 76 such that the point 190 catches on the outer rib wall 80. As a result, the two package halves 52, 54 will remain in the closed position until the hook 188 is disengaged from the outer rib wall 80, allowing the body 184 to then pivot about the pivot point 186 around the second side edge 135. Once the tuck under lid lock 182 and more specifically the hook 188 and body 184 clear the second side edge 135 of the blade-holding package panel 60, the cover 58 can be moved away from the blade-holding package panel 60 such that the package is opened.

In use and operation, a reclosable package 50 of the present invention has a cover 58 that releasably engages a package panel 60 in which a recessed wiper blade receiving cavity 62 releasably receives and retains a pre-curved beam type wiper blade 64 in at least a partially straightened and preferably in a substantially straightened when the cover 58 is closed. When the cover 58 is closed, the convexly outwardly bowed or curved outer wall 124 of the cover 58 is configured to overlie the adapter 68 when the adapter 68 is seated in cradle 66 preferably contacting and even bearing against an outer part of the adapter 68 as depicted in FIG. 4 thereby helping prevent the adapter 68 from popping outwardly out of the cradle 66. The convexly outwardly curved outer wall 124 of the cover 58 has a substantially continuously curved transverse cross section as shown in FIG. 4 with the radius of curvature increasing from adjacent the hinge 56 to adjacent side wall 78 and/or 80 of rib 76 such that at least a portion of a band 175 of the outer wall 124 of cover 58 overlies, preferably bears against, and more preferably clamps an outer part of the seated adapter 68 and/or an outer part of the blade arm end cap(s) 98, and/or 100, airfoil 96 and/or beam 86 of one or both seated wiper blade arms 70, 72 when the cover 58 is closed.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A reclosable wiper blade package in combination with a wiper blade comprising:
an elongate pre-curved beam-blade wiper blade having a pair of elongate blade arms extending oppositely outwardly from a wiper blade mounting adapter; and
a reclosable wiper blade package comprised of a pair of package halves joined by a hinge with one of the package halves comprising a cover and the other one of the package halves comprising a blade-retaining package panel having a cradle configured to resiliently bias the pair of elongate blade arms against a beam seat ledge.

2. The reclosable package and blade combination of claim 1 wherein the blade-retaining package panel has a stiffening rib that extends around at least a portion of the blade-retaining package panel.

3. The reclosable package and blade combination of claim 2 wherein the cradle engages the wiper blade mounting adapter to bias the pair of elongate blade arms against the beam seat ledge.

4. The reclosable package and blade combination of claim 3 wherein the pair of elongate blade arms is disposed in a partially straightened condition when received in a blade-receiving cavity.

5. The reclosable package and blade combination of claim 4 wherein the pair of elongate blade arms is disposed in a substantially straightened condition when received in the blade-receiving cavity.

6. The reclosable package and blade combination of claim 4 wherein the cradle and beam seat ledge are formed to provide snap-fit engagement with the wiper blade when the wiper blade is received in the blade-receiving cavity to releasably retain the wiper blade in the blade-receiving cavity.

7. The reclosable package and blade combination of claim 6 wherein the beam seat ledge is substantially straight.

8. The reclosable package and blade combination of claim 7 wherein the pair of elongate blade arms is straightened against the beam seat ledge.

9. The reclosable package and blade combination of claim 2 wherein the cradle comprises a plurality of adapter support fingers configured to engage the wiper blade mounting adapter and bias the mounting adapter towards the beam seat ledge.

10. The reclosable package and blade combination of claim 2 wherein the stiffening rib engages an outer wall of the cover.

11. The reclosable package and blade combination of claim 2 further comprising a plurality of snap closures that protrude internally from an outer wall of the cover, wherein the plurality of snap closures allows the cover to be releasably engaged with the blade-retaining package panel.

12. The reclosable package and blade combination of claim 2 wherein the wiper blade has an elongate flexible wiping element extending outwardly from the pair of blade arms substantially the length of the wiper blade, the elongate flexible wiping element having an elongate outer squeegee edge, wherein the elongate outer squeegee edge is spaced from cover and the blade-retaining package panel.

13. The reclosable package and blade combination of claim 2 wherein the cover is convexly outwardly curved substantially across the length of the cover.

14. A reclosable wiper blade package in combination with a wiper blade comprising:
an elongate pre-curved beam-blade wiper blade having a pair of elongate blade arms extending oppositely outwardly from a wiper blade mounting adapter;
a reclosable wiper blade package comprised of a pair of package halves joined by a hinge with one of the package halves comprising a cover and the other one of the package halves comprising a blade-retaining package panel having a cradle configured to bias the pair of elongate blade arms against a beam seat ledge;
wherein the reclosable wiper blade package further comprises a snap closure configured to releasably secure the cover to the blade-retaining package panel.

15. The reclosable package and blade combination of claim 14 further comprising a tab lock that is engaged to secure the cover to the blade-retaining package panel.

16. The reclosable package and blade combination of claim 15 further comprising a stiffening rib that extends around at least a portion of the blade-retaining package panel.

17. The reclosable package and blade combination of claim 15 wherein the cradle comprises a plurality of spring fingers configured to engage opposing sides and a top edge of the wiper blade mounting adapter.

18. The reclosable package and blade combination of claim 17 wherein the spring fingers engage the wiper blade mounting adapter to bias the pair of elongate blade arms against the beam seat ledge.

19. The reclosable package and blade combination of claim 18 wherein the pair of elongate blade arms is disposed in a substantially straightened condition when received in a blade-receiving cavity.

20. The reclosable package and blade combination of claim 19 wherein the cradle and beat seat ledge are formed to provide snap-fit engagement with the wiper blade when the wiper blade is received in the blade-receiving cavity to releasably retain the wiper blade in the blade-receiving cavity.

21. The reclosable package and blade combination of claim 18 wherein the spring fingers are configured to engage wiper blade mounting adapters of different dimensions.
